(19) United States
(12) Patent Application Publication
(10) Pub. No.: US 2007/0239996 A1
(43) Pub. Date: Oct. 11, 2007

(54) Method and apparatus for binding computer memory to motherboard

(76) Inventors: Daryl Carvis Cromer, Cary, NC (US); Howard Jeffrey Locker, Cary, NC (US); Randall Scott Springfield, Chapel Hill, NC (US); Rod David Waltermann, Rougemont, NC (US)

Correspondence Address: ROGITZ & ASSOCIATES, 750 B STREET, SUITE 3120, SAN DIEGO, CA, 92101, US

(21) Appl. No.: 11/384,465

(22) Filed: Mar. 20, 2006

(51) Int. Cl. G06F 12/14

(52) U.S. Cl. 713/193

(57) ABSTRACT

Serial presence data in the EEPROM of a DIMM is encrypted with the private key of the motherboard with which the DIMM is intended to be used, so that only BIOS of the intended motherboard can decrypt the SPD to complete booting.

### FIELD OF THE INVENTION

The present invention relates generally to methods and apparatus for binding computer memories to motherboards.

### BACKGROUND OF THE INVENTION

To provide personal computers (PC) to users in emerging countries in which resources may be scarce, the concept of a rental PC has been introduced in which a user pays to use a PC by the month or by access event, spreading the cost of the PC among many months. As understood herein, however, it is important to prevent a user of a rental PC from removing parts of the PC for use in other, typically unauthorized PCs.

One part that is particularly susceptible to such theft is memory modules. Dual in-line memory modules (DIMM) plug in to a PC motherboard to serve as computer memory during operation. As is known in the art, when a computer is turned on, the computer processor invokes a small pre-operating system known as a basic input output system (BIOS). As used herein “BIOS” refers generically to small pre-operating systems including the uEFI system (Unified Extensible Firmware Interface) that is stored in solid state memory of the computer to in turn copy a larger operating system such as Windows (a trademarked name) or Linux and user applications and data from a hard disk drive into the memory of the computer, and this is what memory modules can be used for.

### SUMMARY OF THE INVENTION

A method includes encrypting, with a private key of a computer motherboard, memory information located in a memory module plugged into the motherboard. The memory information is necessary for a memory controller to understand how to read data from and/or to write data to the memory module. At boot time, the memory information is decrypted and provided to a memory controller to enable read and writes to the memory.

Without limitation, the memory information can include type of memory, number of rows in the memory module, number of columns in the memory module, refresh timing, and number of banks of memory in the memory module. In non-limiting implementations the memory module can be a dual in-line memory module (DIMM), and the memory information can be stored in an EEPROM of the DIMM. The BIOS or uEFI of the motherboard can be used to decrypt the memory information.

In another aspect, a computer system includes a processor executing a BIOS to, in response to a boot command, execute logic. The logic includes obtaining a private key, and attempting to decrypt memory information in a memory module using the private key. If the memory information is successfully decrypted, it is provided to a memory controller to complete booting a main operating system into the memory module. Otherwise, the system is not able to complete booting.

In still another aspect, a computer system includes a processor and means accessible to the processor for booting. The system also includes means embodied in the means for booting for decrypting memory information in a memory module. The memory information is necessary to read data from and/or to write data to the memory module.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting system in accordance with the invention; and

FIG. 2 is a flow chart of a non-limiting implementation of the logic.

### DETAILED DESCRIPTION OF THE PREFERRED EMBODIMENT

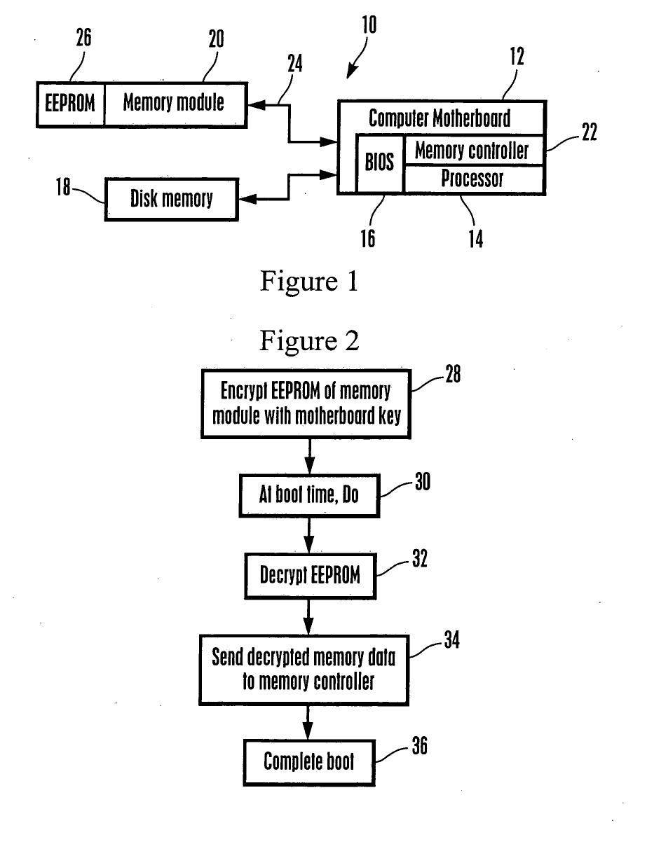

FIG. 1 shows that a non-limiting computer system 10 in which the present invention may be embodied includes a computer motherboard 12 that supports a processor 14 that can execute a basic input-output system (BIOS) 16 to boot a main operating system from a boot source 18 such as but not limited to a hard disk drive (HDD) into one or more memory modules 20 (only one memory module 20 shown for clarity of disclosure). The memory module 20 is controlled by a memory controller 22 under control of the processor 14 during operation to execute the main operating system. The memory controller 22 may be integrated with the processor 14.

In one implementation, the memory module 20 is a DIMM that plugs into the motherboard 12 as indicated by the line 24. Accordingly, the memory module may include at least one electrically erasable programmable read only memory (EEPROM) 26 that stores memory data colloquially know as “serial presence data” or “SPD”. In essence, the memory data can be thought of as memory metadata, and can include information such as the type of memory, number of rows and columns in the memory module, refresh timing, number of banks of memory, and other information in accordance with principles known in the art that is necessary for the memory controller 22 to know in order to exchange data with the memory module 20. It is to be understood, however, that other types of memories are contemplated herein within the scope of the invention.

With the above system architecture in mind, attention is now directed to FIG. 2, wherein at block 28 the memory data in the EEPROM 26 is encrypted using the private key of the motherboard 12, it being understood that the step at block 28 is done at box manufacturing time, as an offline process. Then, at boot time a DO loop is entered at block 30, in which the data in the EEPROM is decrypted at block 32 by the BIOS (which has access to the private key of the motherboard 12, the key being stored, in one non-limiting implementation, in a trusted platform module (TPM) associated with the motherboard 12). The decrypted memory information is provided to the memory controller 22 at block 34, so that the memory controller can complete booting at block 36 in accordance with booting principles known in the art.

It may now be appreciated that if the memory module 20 is removed from the motherboard 12, it cannot be used with another motherboard because the data necessary for the memory controller of the other system to use the memory module 20 will remain encrypted in the EEPROM 26, the private key of the authorized motherboard 12 not being available to the other system. Also, since the unauthorized second system would not be able to complete booting of the main operating system it would remain stuck in BIOS, rendering it unlikely that the BIOS could be used to determine the content of the EEPROM. It would be virtually impossible for an unauthorized BIOS to hack the EEPROM because the EEPROM size would require trying a huge (for a typical BIOS) amount of combinations to “crack” the memory data in the EEPROM. Further, BIOS would not even know what the correct data is that it requires from the EEPROM.

While the particular METHOD AND APPARATUS FOR BINDING COMPUTER MEMORY TO MOTHERBOARD as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A method comprising:
encrypting, with a private key of a computer motherboard, memory information located in a memory module engageable with the motherboard, the memory information being necessary for a memory controller to read data from and/or to write data to the memory module;
at boot time, decrypting the memory information to render decrypted memory information; and
providing the decrypted memory information to a memory controller to enable completion of the boot.

2. The method of claim 1, wherein the memory information includes at least one parameter in the group consisting of: type of memory, number of rows in the memory module, number of columns in the memory module, refresh timing, number of banks of memory in the memory module.

3. The method of claim 1, wherein the memory module is an in-line memory module.

4. The method of claim 3, wherein the memory information is stored in an EEPROM.

5. The method of claim 1, wherein the act of decrypting is undertaken using a basic input-output system (BIOS) associated with the motherboard.

6. A computer system, comprising:
a processor executing a BIOS to, in response to a boot command, execute logic comprising:
obtaining a private key;
attempting to decrypt memory information in a memory module using the private key; and
if the memory information is successfully decrypted, providing it to a memory controller to complete booting a main operating system into the memory module, otherwise not being able to complete booting.

7. The system of claim 6, wherein the processor is mounted on a motherboard, and the private key is associated with the motherboard.

8. The system of claim 7, wherein the memory module is pluggable into the motherboard.

9. The system of claim 8, wherein the memory information includes at least one parameter in the group consisting of: type of memory, number of rows in the memory module, number of columns in the memory module, refresh timing, number of banks of memory in the memory module.

10. The system of claim 9, wherein the memory module is an in-line memory module.

11. The system of claim 10, wherein the memory information is stored in an EEPROM.

12. A computer system, comprising:
a processor;
means accessible to the processor for booting; and
means embodied in the means for booting for decrypting memory information in at least one memory module, the memory information being necessary to at least read data from and/or to write data to the memory module.

13. The system of claim 12, wherein the processor is mounted on a motherboard, and the means for decrypting uses a private key associated with the motherboard.

14. The system of claim 12, wherein the memory module is pluggable into a computer motherboard.

15. The system of claim 12, wherein the memory information includes at least one parameter in the group comprising: type of memory, number of rows in the memory module, number of columns in the memory module, refresh timing, number of banks of memory in the memory module.

16. The system of claim 12, wherein the memory module is an in-line memory module.

17. The system of claim 16, wherein the memory information is stored in an EEPROM.
